(19) United States
(12) Patent Application Publication
(10) Pub. No.: US 2025/0099791 A1
(43) Pub. Date: Mar. 27, 2025

(54) DOCKING APPARATUS AND METHOD FOR COOPERATIVE FIRE SUPPRESSION SYSTEM FOR VEHICLES

(71) Applicants: Hyundai Motor Company, Seoul (KR); Kia Corporation, Seoul (KR)

(72) Inventor: Hyeon Gi SHIN, Yongin-Si (KR)

(73) Assignees: Hyundai Motor Company, Seoul (KR); Kia Corporation, Seoul (KR)

(21) Appl. No.: 18/662,347

(22) Filed: May 13, 2024

(30) Foreign Application Priority Data
Sep. 27, 2023 (KR) 10-2023-0129976

(51) Int. Cl. A62C 3/07; A62C 31/28

(52) U.S. Cl. CPC A62C 3/07; A62C 31/28

(57) ABSTRACT

In a docking apparatus and method for a cooperative fire suppression system for vehicles which docks a surrounding vehicle with an inflamed vehicle to supply firefighting water to the inflamed vehicle, the docking apparatus includes a firefighting water inflow pipe provided in a first vehicle to receive firefighting water, a firefighting water supply pipe provided in a second vehicle to be capable of docking with the firefighting water inflow pipe, and moved to a position where docking with the firefighting water inflow pipe is possible through driving of the second vehicle, and a height adjustment module provided in the second vehicle and configured to adjust a height of the firefighting water supply pipe to coincide with a height of the firefighting water inflow pipe.

### CROSS-REFERENCE TO RELATED APPLICATION

The present application claims priority to Korean Patent Application No. 10-2023-0129976 filed on Sep. 27, 2023, the entire contents of which is incorporated herein for all purposes by this reference.

### BACKGROUND OF THE PRESENT DISCLOSURE

### Field of the Present Disclosure

The present disclosure relates to a docking apparatus and method for a cooperative fire suppression system for vehicles. It relates to a docking apparatus and method for a cooperative fire suppression system for vehicles which docks a surrounding vehicle with an inflamed vehicle to supply firefighting water to the inflamed vehicle.

### Description of Related art

Recently, with the increasing use of eco-friendly vehicles, such as electric vehicles or fuel cell vehicles, the risk of fires due to external shock or internal short circuit in batteries or high-voltage electric wiring mounted in these vehicles is increasing.

Eco-friendly vehicles have a common point in traveling by drive motors using electric power charged in batteries (or “battery packs”), and may be referred to as electric vehicles in a broad sense. High-voltage battery packs configured to supply power to a motor is mounted in such an electric vehicle, and the high-voltage battery packs are repeatedly charged and discharged while driving of the vehicle and thus supplies electric power to a power electronic system including the motor.

The battery pack of the electric vehicle generally includes a battery case, and a plurality of battery modules disposed in the battery case. Furthermore, the battery pack includes a configuration for preventing a fire by cutting off a fuse or cutting off a relay connected to an inverter when internal short circuit occurs or over current flows.

However, a fire may occur on the battery packs, electric wiring, etc. due to various reasons, such as collision or malfunction of parts, while driving of the electric vehicle, and when the fire is not properly suppressed, the fire may cause the burning of the vehicle and may thus cause huge material and human damages.

The fire of the battery pack may spread in a short time due to structures and components of the battery pack, and in the case of a public transportation vehicle, such as a bus, on which many passengers are riding, rapid fire response is essential for passenger safety, and the fire may lead to a main disaster when the initial response to the fire fails.

However, use of fire extinguishers provided in vehicles is only known as a method of responding to fires. Even in the instant case, when a driver does not use a fire extinguisher on time, the initial response to a fire fails, and thus, the fire may spread the entirety of the vehicle, and the risk of human damage may be increased. Even though the driver or passengers in the vehicle rapidly recognize occurrence of the fire, it may be difficult to suppress the fire only using small fire extinguishers provided in the vehicle.

In the case that a standpipe system is located around the vehicle or there is a fire engine near to the scene of the fire, firefighting water may be supplied to the vehicle, but otherwise, it is difficult to extinguish the fire at the early stage.

Therefore, measures to more rapidly suppress a fire occurring in a driving vehicle at the early stage are desperately needed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing technology which may rapidly suppress a fire occurring in an eco-friendly vehicle at the early stage through cooperation with surrounding vehicles is being conducted now.

According to current ongoing research, spray of fire firing water from the outside thereof to an inflamed vehicle is hardly conducive to suppressing a fire. To suppress the fire at the early stage, it is effective to spray firefighting water directly to the inside of the inflamed vehicle.

Therefore, a docking structure between an inflamed vehicle and a surrounding vehicle to supply firefighting water directly to the inside of the inflamed vehicle from the surrounding vehicle is required.

Various aspects of the present disclosure are directed to providing a docking apparatus and method for a cooperative fire suppression system for vehicles which docks a surrounding vehicle with an inflamed vehicle to supply firefighting water to the inflamed vehicle, to rapidly suppress a fire occurring in the inflamed vehicle through cooperation with the surrounding vehicle.

Various aspects of the present disclosure are directed to providing a docking apparatus for a cooperative fire suppression system for vehicles, including a firefighting water inflow pipe provided in a first vehicle to receive firefighting water, a firefighting water supply pipe provided in a second vehicle to be configured for docking with the firefighting water inflow pipe, and moved to a position where docking with the firefighting water inflow pipe is possible through driving of the second vehicle, and a height adjustment module provided in the second vehicle and configured to adjust a height of the firefighting water supply pipe to coincide with a height of the firefighting water inflow pipe.

In an exemplary embodiment of the present disclosure, the height adjustment module may include a first magnet provided on the firefighting water supply pipe, and a second magnet mounted on the second vehicle and configured to be spaced from the first magnet in a vertical direction, one of the first magnet and the second magnet may be a permanent magnet, and a remaining one may be an electromagnet configured to generate magnetic force to move the firefighting water supply pipe in the vertical direction when current is applied to the electromagnet.

In another exemplary embodiment of the present disclosure, a current value applied to the electromagnet may be determined based on a movement amount of the firefighting water supply pipe, and the movement amount of the firefighting water supply pipe may be a vertical movement amount of the firefighting water supply pipe to locate the firefighting water supply pipe at a same height as the firefighting water inflow pipe.

In various exemplary embodiments of the present disclosure, horizontal movement of the firefighting water supply pipe may be restricted by a stopper provided in the second vehicle.

In various exemplary embodiments of the present disclosure, the stopper may include a guide groove configured so that a connector provided on the firefighting water supply pipe is inserted thereinto, and the guide groove may be indented into the stopper in a vertical direction thereof.

In still various exemplary embodiments of the present disclosure, the stopper may be moved in a direction of being separated from the connector of the firefighting water supply pipe by driving of a first motor provided in the second vehicle, when docking between the firefighting water inflow pipe and the firefighting water supply pipe is completed.

In another exemplary embodiment of the present disclosure, the firefighting water supply pipe may include a flexible hose including a first end portion connected to a tank of the second vehicle configured to store the firefighting water, a connector provided on a second end portion of the flexible hose and provided with the first magnet mounted thereon, and an extension pipe connected to the flexible hose through the connector, configured for extending in a longitudinal direction of the extension pipe, and includes a joint coupled to the firefighting water inflow pipe.

In another further embodiment, the extension pipe may be pressed in a direction of extending by a spring member in a compressed state provided on the connector.

In yet another further embodiment, the spring member may be supported in the compressed state by a flap neighboring to the joint of the extension pipe, and the flap may be configured to open or close a supply pipe opening provided in an external body of the second vehicle.

In yet another further embodiment, the flap may open the supply pipe opening by driving a second motor, when the firefighting water supply pipe is located at the position where the docking with the firefighting water inflow pipe is possible.

In still yet another further embodiment, a pressure sensor configured for measuring a pressure applied to the joint coupled to the firefighting water inflow pipe may be provided on the extension pipe, and whether or not docking between the firefighting water inflow pipe and the extension pipe is executed may be determined based on a pressure value measured by the pressure sensor.

In a still further embodiment, the firefighting water inflow pipe may be connected to battery cases of battery packs provided in the first vehicle, and the firefighting water supplied to the firefighting water inflow pipe through the firefighting water supply pipe may flow into the battery cases.

Various aspects of the present disclosure are directed to providing a docking method for a cooperative fire suppression system for vehicles, including moving a second vehicle including a firefighting water supply pipe to a first position within a predetermined distance from a first vehicle including a firefighting water inflow pipe at a request of the first vehicle, moving the firefighting water supply pipe to a second position where docking with the firefighting water inflow pipe is possible based on position information of the firefighting water inflow pipe by driving of the second vehicle and operation of a height adjustment module provided in the second vehicle, when the second vehicle arrives at the first position, extending an extension pipe provided in the firefighting water supply pipe toward the firefighting water inflow pipe by opening a flap configured to open or close a supply pipe opening provided in an external body of the second vehicle, when the firefighting water supply pipe is located at the second position, and docking the extended extension pipe with the firefighting water inflow pipe to supply firefighting water to the firefighting water inflow pipe.

In an exemplary embodiment of the present disclosure, moving the firefighting water supply pipe to the second position may include moving the second vehicle so that a horizontal position of the firefighting water supply pipe coincides with a horizontal position of the firefighting water inflow pipe, and moving the firefighting water supply pipe in a vertical direction by the height adjustment module so that a vertical position of the firefighting water supply pipe coincides with a vertical position of the firefighting water inflow pipe.

In another exemplary embodiment of the present disclosure, the firefighting water supply pipe may include a flexible hose including a first end portion connected to a tank of the second vehicle configured to store the firefighting water, a connector provided on a second end portion of the flexible hose and provided with the first magnet mounted thereon, and an extension pipe connected to the flexible hose through the connector, configured for extending in a longitudinal direction of the extension pipe, and pressed in a direction of extending by a spring member in a compressed state provided on the connector.

In various exemplary embodiments of the present disclosure, the spring member may be supported in the compressed state by a flap neighboring to an end portion of the extension pipe, and in extending the extension pipe toward the firefighting water inflow pipe, the extension pipe may extend toward the firefighting water inflow pipe by elastic restoring force of the spring member when the flap opens the supply pipe opening.

In various exemplary embodiments of the present disclosure, docking the extending extension pipe with the firefighting water inflow pipe may include determining whether or not docking between the firefighting water inflow pipe and the firefighting water supply pipe is completed based on a pressure value measured by a pressure sensor provided on the extension pipe of the firefighting water supply pipe, and when the pressure value measured by the pressure sensor is greater than or equal to a set pressure value, a determination may be made that the docking between the firefighting water inflow pipe and the firefighting water supply pipe is completed.

In still various exemplary embodiments of the present disclosure, the docking method may further include separating a stopper configured to restrict horizontal movement of the firefighting water supply pipe from the firefighting water supply pipe, when docking between the firefighting water inflow pipe and the firefighting water supply pipe is completed, securing a safe distance for the second vehicle by moving the second vehicle in a direction away from the first vehicle, and supplying the firefighting water in a tank provided in the second vehicle to the firefighting water inflow pipe through the firefighting water supply pipe, the firefighting water inflow pipe may be connected to battery cases of battery packs provided in the first vehicle, and the firefighting water supplied to the firefighting water inflow pipe through the firefighting water supply pipe may flow into the battery cases.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

Other aspects and embodiments of the present disclosure are discussed infra.

The above and other features of the present disclosure are discussed infra.

### BRIEF DESCRIPTION OF THE DRAWINGS

FIG. 1 is a view showing an inflamed vehicle and surrounding vehicles which perform a cooperative fire suppression process according to an exemplary embodiment of the present disclosure;

FIG. 2 is a block diagram illustrating main components mounted in the inflamed vehicle and a fire suppression vehicle among components of a cooperative fire suppression system according to an exemplary embodiment of the present disclosure;

FIG. 3 is a block diagram illustrating components of the cooperative fire vehicle suppression system according to an exemplary embodiment of the present disclosure, which are mounted in the fire suppression vehicle;

FIG. 4 is a view exemplarily illustrating components of the cooperative fire suppression system for vehicles according to various exemplary embodiments of the present disclosure, which are provided in battery packs of the inflamed vehicle;

FIG. 5, FIG. 6 and FIG. 7 are views exemplarily illustrating one example of docking of the fire suppression vehicle with the inflamed vehicle in an exemplary embodiment of the present disclosure;

FIG. 8 is a view exemplarily illustrating a docking apparatus for the fire suppression system according to various exemplary embodiments of the present disclosure in more detail compared to FIG. 6 and FIG. 7;

FIG. 9 and FIG. 10 are views exemplarily illustrating a process of operating the docking apparatus according to an exemplary embodiment of the present disclosure;

FIG. 11 is a flowchart representing a docking method for the fire suppression system according to an exemplary embodiment of the present disclosure; and

FIG. 12 is a block diagram illustrating the fire suppression system according to various exemplary embodiments of the present disclosure, including a compensation system.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, reference will be made in detail to various embodiments of the present disclosure, examples of which are illustrated in the accompanying drawings and described below. Elements included in the accompanying drawings may schematized to clearly explain the exemplary embodiments of the present disclosure, and may be different from actually implemented forms thereof.

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the present disclosure.

Various embodiments of the present disclosure relate to a cooperative fire suppression system for vehicles which may rapidly suppress a fire occurring in a vehicle at the early stage through cooperation among vehicles. Various aspects of the present disclosure are directed to providing a docking structure and method between vehicles which are required to suppress a fire at the early stage.

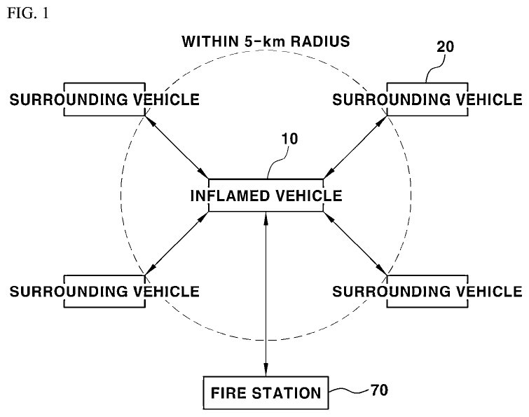

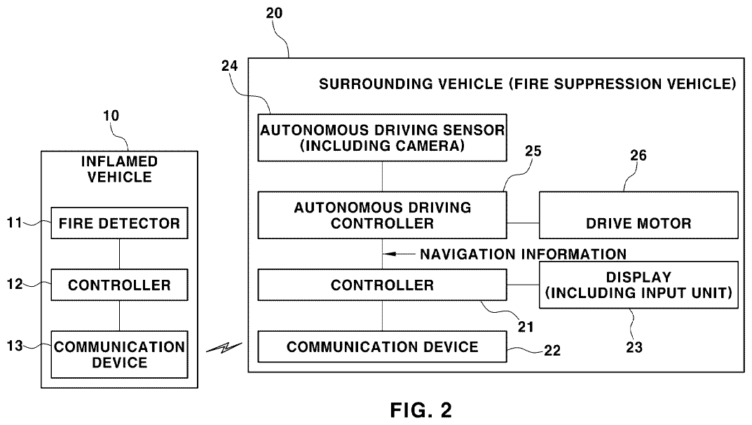

FIG. 1 is a view showing an inflamed vehicle 10 and surrounding vehicles 20 which perform a cooperative fire suppression process according to an exemplary embodiment of the present disclosure, and FIG. 2 is a block diagram illustrating main components mounted in the inflamed vehicle 10 and the fire suppression vehicle 20 among components of a cooperative fire suppression system for vehicles according to an exemplary embodiment of the present disclosure. In the following description, a vehicle in which a fire occurs and thus which is subject to fire suppression will be referred to as an “inflamed vehicle”.

The fire suppression system according to an exemplary embodiment of the present disclosure may be to suppress a fire occurring in an eco-friendly vehicle. Furthermore, the fire suppression system according to an exemplary embodiment of the present disclosure is configured to suppress a fire in the inflamed vehicle using firefighting water supplied from one of the surrounding vehicles 20, after docking the surrounding vehicle 20 with the inflamed vehicle 10. Here, the fire in the inflamed vehicle 10 may be suppressed through cooperation among a plurality of vehicles.

Here, the inflamed vehicle 10 may be an eco-friendly vehicle, for example, an electric vehicle or a fuel cell vehicle including a high-voltage battery mounted therein. That is, the present disclosure may be used to suppress a fire occurring in an electric vehicle or a fuel cell vehicle, and the fire occurring in the vehicle may be a fire occurring in the battery of the vehicle.

The vehicle 20 participating in fire suppression in an exemplary embodiment of the present disclosure is a vehicle which may dock with the inflamed vehicle 10 to supply firefighting water stored in a tank 35 to the inflamed vehicle 10. Furthermore, the vehicle 20 participating in fire suppression in an exemplary embodiment of the present disclosure is a vehicle which may communicate with the inflamed vehicle 10 or an external system, and is a vehicle which may cooperate with the inflamed vehicle 10 to suppress the fire while exchanging necessary information with the inflamed vehicle 10 through communication.

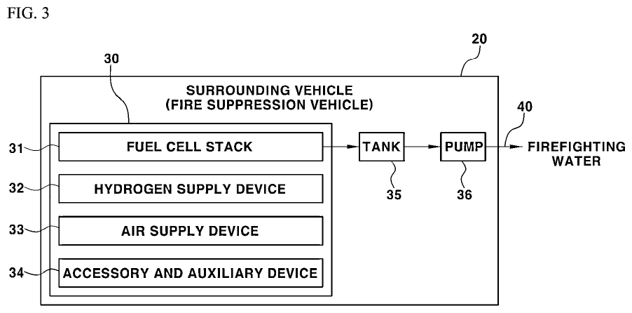

For example, the vehicle 20 participating in fire suppression in an exemplary embodiment of the present disclosure may be a fuel cell vehicle which may store exhaust water generated by and discharged from a fuel cell stack 31 in a tank 35 (in FIG. 3), and may then supply the exhaust water to the inflamed vehicle 10 as firefighting water. Furthermore, the vehicle 20 participating in fire suppression in an exemplary embodiment of the present disclosure may be an autonomous vehicle which may provide firefighting water stored in a tank 35 to the inflamed vehicle 10 and may be driven autonomously.

The fire suppression system according to various exemplary embodiments of the present disclosure is provided in the inflamed vehicle 10, and includes a fire detector 11 provided in the inflamed vehicle 10 and configured to detect a fire occurring in the inflamed vehicle 10, a controller 12 mounted in the inflamed vehicle 10 and configured to enter a fire suppression mode to perform a control process for fire suppression upon determining that the fire occurs in the inflamed vehicle 10, and a communication device 13 mounted in the inflamed vehicle 10 to communicate with the surrounding vehicles 20 and external systems, such as a server of a fire station 70.

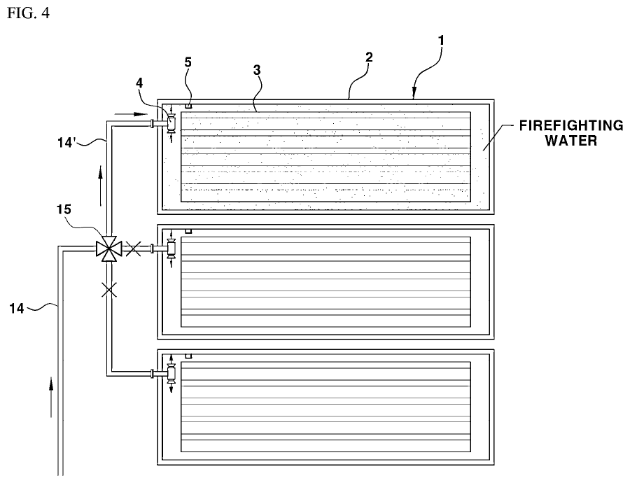

The fire detector 11 in an exemplary embodiment of the present disclosure may be a temperature sensor 5 (in FIG. 4) which detects a temperature, a gas detector which detects the concentration of specific gas, such as carbon monoxide, generated in the event of a vehicle fire, or a fire detection line which outputs an electrical signal due to melding of a cladding material at the time of contact with flame or at a high temperature.

The controller 12 may be configured to determine that the fire occurs in the vehicle 10, when a detected temperature indicated by a signal received from the temperature sensor 4 is equal to or greater than a predetermined temperature, when a detected concentration of carbon dioxide indicated by a signal received from the gas detector is equal to or greater than a set concentration, or when an electrical signal is input from the fire detection line.

The controller 12 in an exemplary embodiment of the present disclosure, in the case that a fire occurs in an ego vehicle, is configured to perform a predetermined control process for fire suppression, which will be described below, i.e., control configured to issue a warning as to the fire occurrence situation to the inside and the outside of the vehicle, or to transmit fire occurrence information through the communication device 13 to inform the outside of fire occurrence and to request fire suppression.

For the present purpose, the fire suppression system according to an exemplary embodiment of the present disclosure may further include a warning device which is operated by a control signal output from the controller 12 of the inflamed vehicle 10 after determining fire occurrence and issues a waring as to the fire occurrence situation. The warning device may be a warning light or a warning sound output device.

The communication device 13 of the inflamed vehicle 10 is configured to perform communication with the surrounding vehicles 20 and the external systems, such as the server of the fire station 70 located at the outside of the inflamed vehicle 10. As the communication device 13 of the inflamed vehicle 10, any known wireless communication device provided to perform communication a corresponding vehicle with the outside through wireless communication may be used without restriction as to communication method.

Furthermore, the fire suppression system according to various exemplary embodiments of the present disclosure includes a fire suppression vehicle 20 which may supply firefighting water and includes a communication device 22 to be communicable with the outside thereof. The fire suppression vehicle 20 means a vehicle which supplies firefighting water to the inflamed vehicle 10 to suppress the fire in the inflamed vehicle 10 after docking with the inflamed vehicle 10, among the surrounding vehicles 20 located around the inflamed vehicle 10. That is, the fire suppression vehicle 20 means a vehicle which participates in fire suppression, among the surrounding vehicles 20 located around the inflamed vehicle 10.

FIG. 3 is a block diagram illustrating components of the cooperative fire suppression system for vehicles according to an exemplary embodiment of the present disclosure, which are mounted in the fire suppression vehicle 20. The surrounding vehicle 20 which may participate in fire suppression in an exemplary embodiment of the present disclosure may be a fuel cell vehicle, as described above, and more particularly, a fuel cell vehicle which may autonomously travel.

Referring to FIG. 3, a fuel cell system 30 is mounted in the fuel cell vehicle, and the fuel cell system 30 include the fuel cell stack 31, a hydrogen supply device 32 configured to supply hydrogen provided as fuel gas, an air supply device 33 configured to supply air including oxygen provided as oxidant gas, and other accessories and auxiliary devices 34 required to operate fuel cells. Furthermore, a drive motor 26 for driving, which is operated by receiving electric power generated by the fuel cell stack 31 and electric power generated by a battery, is generally mounted in the fuel cell vehicle (with reference to FIG. 2).

Furthermore, the tank 35 configured to store exhaust water generated by the fuel cell stack 31 and thus discharged therefrom, and a pump 36 configured to draw the exhaust water stored in the tank 35 and then to supply the exhaust water to a firefighting water supply pipe 40 are mounted in the fire suppression vehicle 20 in an exemplary embodiment of the present disclosure.

Furthermore, when the fire suppression vehicle 20 in an exemplary embodiment of the present disclosure is a fuel cell vehicle which may autonomously travel, general devices for autonomous driving, for example, an autonomous driving controller 35 configured to perform autonomous driving control, and autonomous driving sensors 24 configured to obtain various information required to perform autonomous driving control, are mounted in the fire suppression vehicle, as shown in FIG. 2. For example, the autonomous driving sensors 24 may include a camera configured to obtain image information required for autonomous driving control.

In various exemplary embodiments of the present disclosure, the fire suppression vehicle 20 is located within a set distance around the inflamed vehicle 10, receives fire occurrence information transmitted by the inflamed vehicle 10 through the communication device 22, and is moved to a position, where the fire suppression vehicle 20 may dock with the inflamed vehicle 10, to participate in fire suppression.

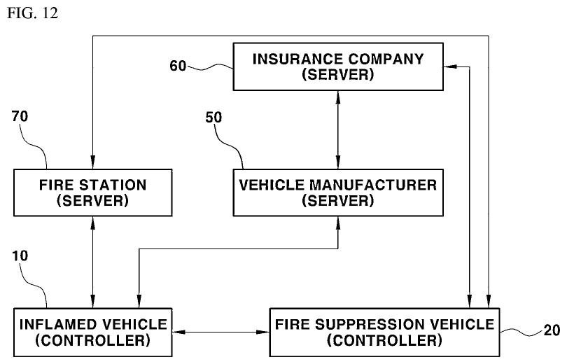

The communication device 22 of the surrounding vehicle 20, which may participate in fire suppression, in an exemplary embodiment of the present disclosure may be no different from the communication device 13 of the inflamed vehicle 10, and may be a wireless communication device which is mounted in the surrounding vehicle 20 to perform wireless communication with the communication device 13 of the inflamed vehicle 10 and the external systems, such as servers of elements 40, 50 and 60 (in FIG. 12).

It is expected that, together with autonomous vehicles, connected vehicles which communicate in real time with other vehicles, transportation and communication infrastructures, and pedestrian terminals, will be spread, and the fire suppression system according to an exemplary embodiment of the present disclosure may be a system including such connected vehicles and autonomous vehicles, or a system using the same.

In various exemplary embodiments of the present disclosure, the controller 12 of the inflamed vehicle 10 transmits the fire occurrence information including a fire occurrence signal informing of occurrence of the fire, a fire suppression request signal, vehicle position information, etc., through the communication device 13, upon determining that the fire occurs in the vehicle 10 through the fire detector 11. The vehicle position information may include the position information of the inflamed vehicle 10 and the position information of a firefighting water inflow pipe 14 provided in the inflamed vehicle 10.

Here, the controller 12 and the communication device 13 of the inflamed vehicle 10 may be set to transmit the fire occurrence information to all surrounding vehicles 20 located within a set radial distance (for example 5 km) from the position of the inflamed vehicle 10.

Furthermore, the controller 12 and the communication device 13 of the inflamed vehicle 10 may be set to transmit the fire occurrence information to the nearest fire station 70, and in the instant case, may transmit the fire occurrence information, including ego vehicle position information, i.e., inflamed vehicle position information, and driver information together with the fire occurrence signal informing of occurrence of the fire, to the fire station 70. Accordingly, the fire station 70 may send fire engines to the inflamed vehicle 10, after receiving the fire occurrence information.

Here, when the fire station 70 receives the fire occurrence information, the fire station 70 may try to talk on the phone with a driver using the driver information of the inflamed vehicle 10, and may send fire engines to the inflamed vehicle 10 after confirming that the fire occurs through a telephone conversation with the driver.

In various exemplary embodiments of the present disclosure, the controller 10 of the inflamed vehicle 10 confirms the position of the fire station 70 and a radial distance up to the fire station 70 based on the current position of the inflamed vehicle 10 using navigation information including map information and real-time traffic information, and is configured to determine a required time for arrival, i.e., a time taken for fire engines to arrive at the current position of the inflamed vehicle 10.

The controller 12 of the inflamed vehicle 10 may be set not to transmit the fire occurrence information to the surrounding vehicles 20, when the radial distance up to the fire station 70 based on the current position (i.e., the real-time position) of the inflamed vehicle 10 is within the set radial distance and the required time for arrival, taken for fire engines to arrive at the current position of the inflamed vehicle 10, is less than or equal to a set time (for example, 15 minutes).

Here, the required time for arrival in which the real-time transportation information is reflected may be used. The reason why the fire occurrence information is not transmitted to the surrounding vehicles 20 when the required time for arrival is less than or equal to the set time is that the fire may be suppressed at the early stage with dispatch of fire engines alone.

When the fire station 70 is located outside the set radial distance or the required time for arrival of fire engines exceeds the set time, the controller 12 of the inflamed vehicle 10 transmits the fire occurrence information to the surrounding vehicles 20 located within the set radial distance to request fire suppression.

In the surrounding vehicle 20 which may participate in fire suppression, the position information of the inflamed vehicle 10 is displayed on a vehicle display 23, and a required time for driving, i.e., a time taken for the surrounding vehicle 20 to travel to the position of the inflamed vehicle 10 from the current position of the surrounding vehicle 20, is determined as a time in which real-time traffic conditions are reflected, and is displayed on the vehicle display 23.

Furthermore, information to ask whether or not to participate in fire suppression and a pop-up window configured to allow a driver to select and input whether or not to participate in fire suppression may be displayed on the display 23. Here, the display 23 may be an in-vehicle display which displays navigation information including map information and position information in the state of being interlocked with a navigation system.

Furthermore, the display 23 may be a display connected to a separate input unit configured to allow the driver to select and input whether or not to participate in fire suppression, or a touchscreen-type display including a configuration integrated with an input unit.

In the present way, the pop-up window configured to allow the driver to select and input whether or not to participate in fire suppression may be displayed on the display 23 of the surrounding vehicle 20 located around the inflamed vehicle 10 and having received the fire occurrence information from the inflamed vehicle 10, and then, the driver may select and input whether or not to participate in fire suppression in the pop-up window displayed on the display 23.

Here, a participation selection button may be displayed in the pop-up window, and the driver may select whether or not to participate in fire suppression by touching the participation selection button displayed in the pop-up window.

Furthermore, when the driver of the surrounding vehicle 20 having received the fire generation information selects and inputs participation in fire suppression, a fire suppression participation signal indicating the intention to participate in fire suppression may be transmitted to the inflamed vehicle 10 through the communication device 22.

Accordingly, the controller 12 of the inflamed vehicle 10 sets the surrounding vehicle 20 which has transmitted the fire suppression participation signal, as the fire suppression vehicle 20, based on the fire suppression participation signal received through the communication device 13. Here, the controller 12 of the inflamed vehicle 10 transmits a fire suppression request signal to the fire suppression vehicle 20 through the communication device 13.

Furthermore, a water level sensor 35a may be provided in the tank 35 of the surrounding vehicle 20, which may participate in fire suppression, configured to store firefighting water, i.e., the tank 35 configured to store exhaust water in the fuel cell vehicle.

Here, the controller 21 of the surrounding vehicle 20 obtains current level information of the exhaust water in the tank 35 from a signal from the water level sensor 35a, and allows the driver to select and input whether or not to participate in fire suppression only when the obtained current level of the exhaust water in the tank 35 is equal to or greater than a predetermined water level.

For the present purpose, the controller 21 of the surrounding vehicle 20 may activate the participation selection button in the pop-up window displayed on the display 23 only when the obtained current level of the exhaust water in the tank 35 is equal to or greater than the predetermined water level.

Furthermore, in various exemplary embodiments of the present disclosure, the controller 12 of the inflamed vehicle 10 may designate only a set number of vehicles 20 in an order of arrival, among the surrounding vehicles 20 having transmitted the fire suppression participation signal, as fire suppression vehicles 20, and may transmit the fire suppression request signal only to the set number of fire suppression vehicles 20.

Together with selection of the fire suppression vehicles 20, the controller 12 of the inflamed vehicle 10 transmits a signal indicating that participation in fire suppression is not allowed to the remaining surrounding vehicles 20, when the number of the surrounding vehicles 20 designated as the fire suppression vehicles 20 reaches the set number.

In an exemplary embodiment of the present disclosure, the reason why the number of the fire suppression vehicles 20 is restricted to the set number is to prevent traffic congestion caused by a large number of vehicles participating in fire suppression.

In an exemplary embodiment of the present disclosure, the controller 12 of the inflamed vehicle 10 may adjust the set number of fire suppression vehicles 20 depending on real-time traffic conditions and road conditions. For example, the controller 12 of the inflamed vehicle 10 may receive and use navigation information (information provided by the navigation system), and may be configured to determine the set number of fire suppression vehicles 20 based on vehicle average speed information on a surrounding road among the navigation information.

Here, a set number of fire suppression vehicles 20 may be predetermined in each of respective sections divided depending on vehicle average speeds, and in the event of an actual fire, a corresponding set number of vehicles may be determined from a vehicle average speed on a surrounding road, and may be used to restrict the number of fire suppression vehicles 20. In a section having a lower vehicle average speed, the controller 12 may set the number of fire suppression vehicles 20 to a lower value.

In various exemplary embodiments of the present disclosure, in the case of the surrounding vehicle 20 finally selected as the fire suppression vehicle 20 by selecting and inputting participation in fire suppression by the driver, the autonomous driving controller 25 may perform autonomous driving control to drive the fire suppression vehicle 20 to the position of the inflamed vehicle 10 in an autonomous driving mode. Concretely, the position of the inflamed vehicle 10 may indicate a position where the fire suppression vehicle 20 may dock with the inflamed vehicle 10.

Furthermore, when the fire suppression vehicle 20 arrives at the position of the inflamed vehicle 10, docking between both vehicles 10 and 20 is performed by connecting firefighting water paths of the vehicles 10 and 20 to supply firefighting water from the fire suppression vehicle 20 to the inflamed vehicle 10.

When a plurality of fire suppression vehicles 20 arrives at the position of the inflamed vehicle 10, the fire suppression vehicle 20 which arrived first docks with the inflamed vehicle 10 to supply firefighting water to the inflamed vehicle, and the remaining fire suppression vehicles 20 which arrived at the position of the inflamed vehicle 10 are controlled to stand by in the autonomous driving mode at positions around the inflamed vehicle 10.

In various exemplary embodiments of the present disclosure, the fire may be a fire occurring in the battery, as described above, and more concretely, may be a fire occurring in the battery pack.

FIG. 4 is a view exemplarily illustrating main components of the cooperative fire suppression system for vehicles according to various exemplary embodiments of the present disclosure, which are provided in battery packs 1 of the inflamed vehicle 10. FIG. 4 illustrates the firefighting water inflow pipe 14 and nozzles 4 configured to supply firefighting water, and the fire detector 11, together with the battery packs 1.

In an exemplary embodiment of the present disclosure, the battery pack 1 may include a battery case 2, and a battery module 3 disposed in the battery case 2. The battery module 3 received in the battery case 2 includes a plurality of battery cells.

In an exemplary embodiment of the present disclosure, the battery case 2 is provided in a structure including an internal space which may be filled with firefighting water. For the present purpose, the internal space of the battery case 2 in which the battery module 3 is received may be sealed.

That is, the battery case 2 is provided in a structure which seals the battery module 3 while surrounding the battery module 3 including the battery cells, and accordingly the internal space of the battery case 2 may be filled with firefighting water.

The firefighting water inflow pipe 14 configured to inject firefighting water therethrough is connected to the battery case 2, and firefighting water supplied from the fire suppression vehicle 20 having docked with the inflamed vehicle 10 fills the internal space of the battery case 2 through the firefighting water inflow pipe 14, and thereby suppresses a fire occurring in the battery module 3.

As described above, the present disclosure may suppress a fire occurring in the internal space of the battery case 2 surrounding the battery module 3, and may suppress the fire by supplying firefighting water to the internal space of the battery case 2 to fill the internal space of the battery case 2. The firefighting water filling the internal space of the battery case 2 maintains the cooling state of the battery cells, preventing reignition and thermal runaway in the battery cells.

A plurality of battery packs 1 may be mounted in a vehicle, as shown in FIG. 4, and in the instant case, in the state in which the nozzle 4 for battery fire suppression is provided in each of the respective battery packs 1, the firefighting water inflow pipe 14 to which the firefighting water supply pipe 40 of the fire suppression vehicle 20 is connected is branched off toward the respective battery packs 1 at a downstream position of a control flow valve 15, and branched firefighting water inflow pipes 14′ are connected to the nozzles 4 for battery fire suppression of the respective battery packs 1.

Therefore, the controller 12 of the inflamed vehicle 10 determine a battery pack 1 in which the fire occurs based on a signal from the fire detector 11 (in FIG. 2, i.e., a temperature sensor 5 in FIG. 4), and is configured to control the opening amount of the flow control valve 15 to open a branched firefighting water inflow pipe 14′ connected to the battery pack 1 in which the fire occurs, among the branched inflow pipes 14′.

When firefighting water is supplied to the corresponding battery pack 1 through the firefighting water inflow pipe 14 from the fire suppression vehicle 20 having docked with the inflamed vehicle 10, the firefighting water may be injected into the internal space of the battery case 2 through the nozzle 4 in the battery pack 1 in which the fire occurs, and may thus fill the internal space of the battery case 2.

In FIG. 4, reference numeral 5 indicates the temperature sensor, and the temperature sensor 5 corresponds to a fire detector which detects the fire occurring in the battery pack 1. Like this, the fire detector 11 (in FIG. 2) which detects the fire occurring in the battery pack 1 may be the temperature sensor 5.

Furthermore, in an exemplary embodiment of the present disclosure, the surrounding vehicles 20 receive the fire occurrence information transmitted by the inflamed vehicle 10 wirelessly, and the fire suppression vehicles 20 selected among the surrounding vehicles 20 which have received the fire occurrence information are moved around the inflamed vehicle 10 to participate in fire suppression.

Here, a plurality of fire suppression vehicles 20 may communicate with the inflamed vehicle 10 to participate in fire suppression while exchanging information with the inflamed vehicle 10, and the plurality of fire suppression vehicles 20 having arrived at the position of the inflamed vehicle 10 to suppress the fire may sequentially dock with the inflamed vehicle 10 to supply firefighting water.

That is, the fire suppression vehicle 20 which arrived first may dock with the inflamed vehicle 10 and may then supply firefighting water to the inflamed vehicle 10, and when the fire suppression vehicle 20 exhausted the firefighting water stored therein, the fire suppression vehicle 20 may stop operation of the pump 36 and may then be automatically separated from the inflamed vehicle 10. Thereafter, the next fire suppression vehicle 20 may dock with the inflamed vehicle 10 and may then supply firefighting water to the inflamed vehicle 10.

Here, the order of the fire suppression vehicles 20 docking with the inflamed vehicle 10 and supplying firefighting water to the inflamed vehicle 10 may be set to the order of arrival at the position of the inflamed vehicle 10, and the fire suppression vehicles 20 dock with the inflamed vehicle 10 in an order of arrival, and supply firefighting water to the inflamed vehicle 10 to suppress the fire in the inflamed vehicle 10.

Furthermore, the controller 12 of the fire suppression vehicle 10 makes a request for moving to a safe place to the controllers 21 of the fire suppression vehicles 20 standing by around the fire suppression vehicle 10 a set time (for example, 2 to 3 minutes) before arrival of fire engines so as not to interrupt entry of the fire engines, and the fire suppression vehicles 20 standing by around the fire suppression vehicle 10 may be moved to the safe place at the request of the controller 12 of the fire suppression vehicle 10. Here, the autonomous driving controllers 25 of the fire suppression vehicles 20 standing by perform autonomous driving control to move the ego vehicles 20 to the safe place.

Otherwise, the controllers 21 of the fire suppression vehicles 20 standing by may receive the positions of the fire engines from the fire station 70 in real time, and the autonomous driving controllers 25 of the fire suppression vehicles 20 may perform autonomous driving control to move the ego vehicles 20 to the safe place the set time (for example, 2 to 3 minutes) before arrival of the fire engines.

When the fire engines arrives at the scene of the fire, a firefighter separates the firefighting water supply pipe 40 of the fire suppression vehicle 20 from the inflamed vehicle 10, connects a fire hose of the fire engine to the inflamed vehicle 10 to supply firefighting water, and supplies firefighting water stored in the tank of the fire engine to the inflamed vehicle 10, suppressing the fire in the inflamed vehicle 10.

In various exemplary embodiments of the present disclosure, the fire suppression vehicle 20 may be moved or driven in the autonomous driving mode during some of the above-described processes or the entire processes, i.e., the process of moving the fire suppression vehicle 20 to the position of the inflamed vehicle 10, the process of moving the fire suppression vehicle 20 to a docking position to dock with the inflamed vehicle 10, and the process of moving the fire suppression vehicle 20 standing by after arriving at the position of the inflamed vehicle 10 to the safe place just before arrival of the fire engines.

Of course, in a situation in which the autonomous driving mode is unable to be executed, the fire suppression vehicle 20 may be driven and moved in a manual mode in the state in which the autonomous driving mode is released depending on driver determination. The fire suppression vehicle 20 may be also moved or driven in the manual mode during some of the above-described processes or the entire processes.

For example, the controller 12 of the inflamed vehicle 10 may transmit the internal temperatures of the battery packs 1 detected by the temperature sensors 5 to the fire suppression vehicle 20 through the communication device 13.

Here, the controller 21 of the fire suppression vehicle 20 releases the autonomous driving mode by communicating with the autonomous driving controller 25, when the internal temperature of the battery pack 1 received through the communication device 22 is equal to or greater than a predetermined temperature (for example, 200° C.).

Thereafter, the controller 21 of the fire suppression vehicle 20 guides the driver to move the fire suppression vehicle 20 to a safe place in the manual mode through the display 23 and the like. When the internal temperature of the battery pack 1 of the inflamed vehicle 10 is equal to or greater than the predetermined temperature, for example, 200° C., it is determined that thermal runaway occurs in the battery pack 1 and it is difficult to suppress the fire in the battery pack 1, and thus, the fire suppression vehicle 20 is moved to a safe place in the manual mode.

Here, a flap 14b and the flow control valve 15 in the inflamed vehicle 10 are closed to prevent the fire in the battery pack 1 from spreading.

Hereinafter, the structure of docking the fire suppression vehicle 20 with the inflamed vehicle 10 to supply firefighting water to the inflamed vehicle 10 in the fire suppression system according to various exemplary embodiments of the present disclosure will be described.

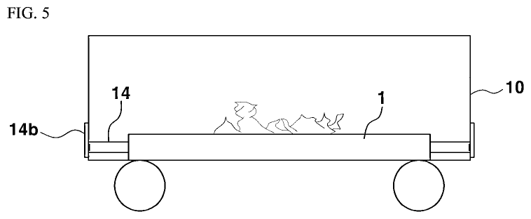

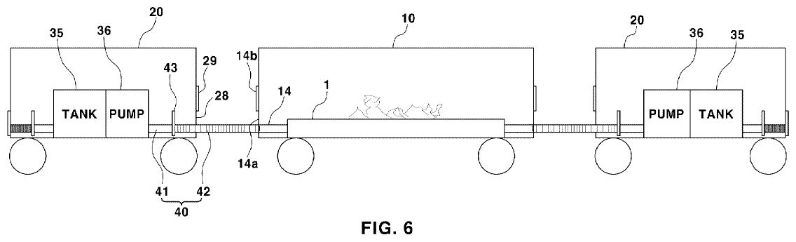

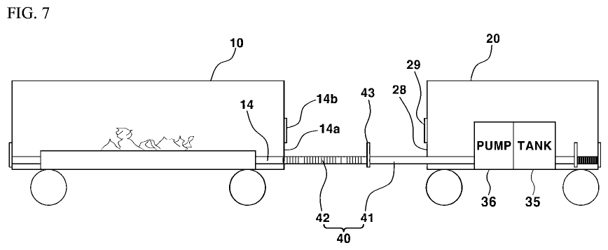

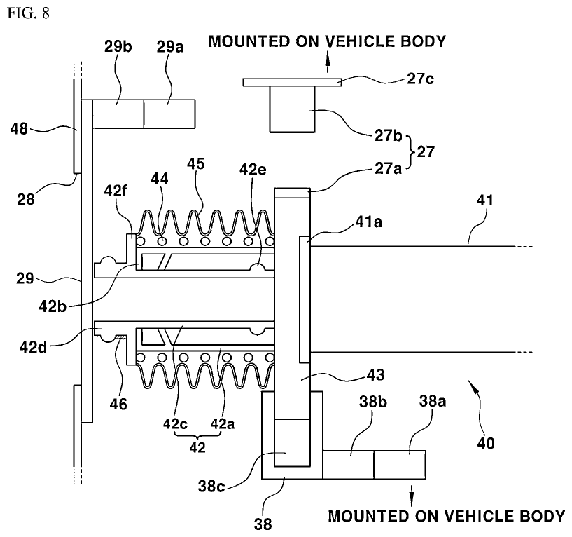

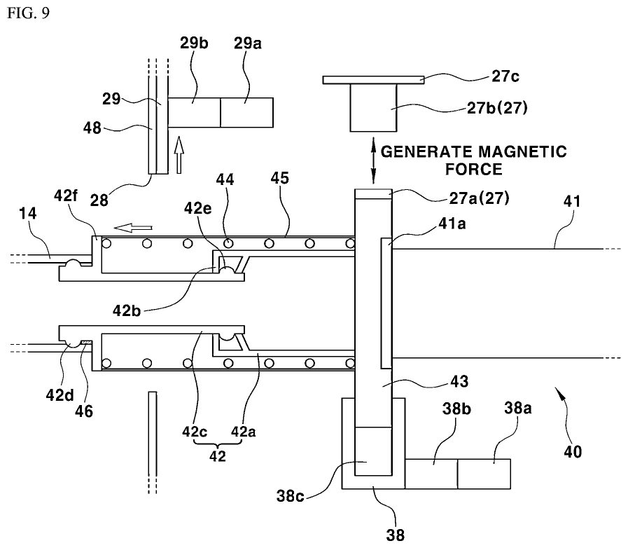

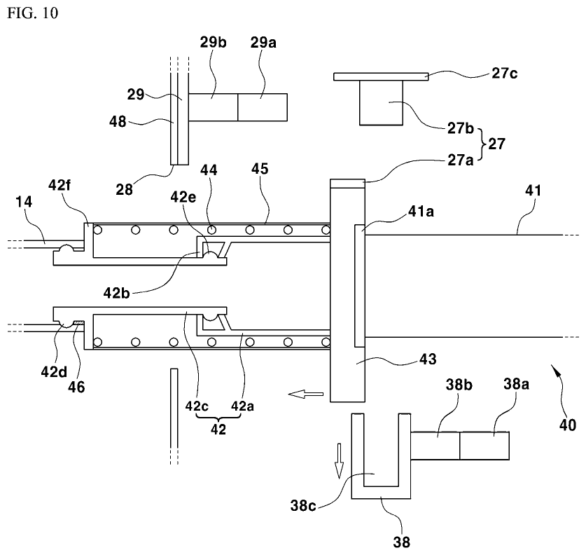

FIG. 5, FIG. 6 and FIG. 7 are views exemplarily illustrating one example of docking of the fire suppression vehicle 20 with the inflamed vehicle 10 in an exemplary embodiment of the present disclosure, FIG. 8 is a view exemplarily illustrating a docking apparatus for the fire suppression system according to various exemplary embodiments of the present disclosure in more detail compared to FIG. 6 and FIG. 7, and FIG. 9 and FIG. 10 are views exemplarily illustrating a process of operating the docking apparatus according to various exemplary embodiments of the present disclosure.

As shown in FIGS. 6 to 8, the fire suppression vehicle 20 includes the firefighting water supply pipe 40 which may dock with the firefighting water inflow pipe 14 of the inflamed vehicle 10, and the firefighting water supply pipe 40 is moved to a position where docking with the firefighting water inflow pipe 14 is possible through driving of the fire suppression vehicle 20.

Furthermore, the fire suppression vehicle 20 includes a height adjustment module 27 configured to adjust the height of the firefighting water supply pipe 40 to coincide with the height of the firefighting water inflow pipe 14 (i.e., the position thereof in the vertical direction).

The firefighting water supply pipe 40 includes a flexible hose 41 including a first end portion connected to the firefighting water tank 35, a connector 43 provided on a second end portion of the flexible hose 41, and an extension pipe 42 connected to the flexible hose 41 through the connector 43 so that the firefighting water may flow therebetween.

The firefighting water tank 35 stores the exhaust water generated by and discharged from the fuel cell stack 31 as the firefighting water is supplied to the firefighting water inflow pipe 14, and is connected to the first end portion of the flexible hose 41 through the pump 36. The pump 36 draws the firefighting water stored in the tank 35, and sends the firefighting water to the flexible hose 41.

The connector 43 is detachably coupled to the second end portion of the flexible hose 41, and is connected to the body of the fire suppression vehicle 20 to be supported thereby to be movable in the vertical direction. Here, the connector 43 is connected to the body of the fire suppression vehicle 20 by a stopper 38 and a motor 38a for moving the stopper 38.

The extension pipe 42 is configured to be capable of extending and being deployed in the longitudinal direction and axial direction thereof, and includes a joint 42d coupled to one end portion of the firefighting water inflow pipe 14. The extension pipe 42 may be provided in a multi-pipe structure in which hard pipes overlap, and may be deployed horizontally to the outside of the body of the fire suppression vehicle 20 through a supply pipe opening 28 opened by the flap 29 of the fire suppression vehicle 20, to extend (with reference to FIG. 9).

Referring to FIG. 9, when the extension pipe 42 extends, the joint 42d of the extension pipe 42 may be coupled to the firefighting water inflow pipe 14 of the inflamed vehicle 10. The supply pipe opening 28 is provided in the body of the fire suppression vehicle 20, and concretely, is provided in an external body 48 of the fire suppression vehicle 20 so that the extension pipe 42 having passed through the supply pipe opening 28 is withdrawn to the outside of the fire suppression vehicle 20.

Referring to the exemplary embodiment shown in FIG. 8, the extension pipe 42 includes a first pipe 42a including a first end portion fixed to the connector 43, and a second pipe 42c inserted into the first pipe 42a to overlap the first pipe 42a to be movable in the longitudinal direction and axial direction thereof.

The second pipe 42c includes a first end portion provided with the joint 42d and a second end portion provided with a protrusion 42e. When the second pipe 42c is linearly moved in a direction of withdrawing from the first pipe 42a, the protrusion 42e is caught by an engaged portion 42b of the first pipe 42a and thus movement of the second pipe 42c is stopped, and the joint 42d is coupled to the end portion of the firefighting water inflow pipe 14. The joint 42d may be directly coupled to the end portion of the firefighting water inflow pipe 14 by press fitting.

Furthermore, a pressure sensor 46 configured for measuring a pressure applied to the joint 42d is provided on the extension pipe 42. The pressure sensor 46 may measure the pressure applied to the joint 42d when the joint 42d is coupled to the firefighting water inflow pipe 14 by press fitting, and may be directly provided on the joint 42d. Whether or not docking between the firefighting water inflow pipe 14 and the extension pipe 42 of the firefighting water supply pipe 40 is conducted may be determined based on a pressure value measured by the pressure sensor 46.

The extension pipe 42 is pressed in a direction of extending by a spring member 44 in a compressed state provided on the connector 43. The spring member 44 includes a first end portion fixedly mounted on the connector 43, and a second end portion fixedly mounted on the extension pipe 42.

The extension pipe 42 includes a bracket 42f to which the second end portion of the spring member 44 is coupled, and the bracket 42f is provided on the second pipe 42c withdrawn from the first pipe 42a to extend the extension pipe 42. The spring member 44 is pressed into the compressed state to be supported to have elastic restoring force, as the joint 42d of the second pipe 42c comes into contact with the flap 29, and the second pipe 42c is withdrawn from the first pipe 42a by the elastic restoring force of the spring member 44 when the flap 29 opens the supply pipe opening 28 (with reference to FIG. 9). Here, the length of the extension pipe 42 is extended starting from the connector 43, and the joint 42d is connected to the end portion of the firefighting water inflow pipe 14 via the supply pipe opening 28.

Although not shown in the drawings, a structure matching the joint 42d may be provided on the end portion of the firefighting water inflow pipe 14. For example, a groove structure with which a protrusion structure of the joint 42d is engaged may be provided in the internal circumferential surface of the end portion of the firefighting water inflow pipe 14.

Furthermore, a corrugated pipe 45 configured to cover the spring member 44 to protect the spring member 44 may be provided on the connector 43. The corrugated pipe 45 is provided to be expandable, and includes a first end portion coupled to the connector 43 and a second end portion coupled to the bracket 42f of the extension pipe 42.

The flap 29 is configured to open or close the supply pipe opening 28 provided in the body of the fire suppression vehicle 20, is connected to the motor 29a for moving the flap 29 through a rack and pinion gear set 29b, and is elevated and lowered by driving the motor 29a for moving the flap 29 to open or close the supply pipe opening 28.

The height (i.e., the position in the vertical direction) of the firefighting water supply pipe 40 is adjusted by the height adjustment module 27 provided in the fire suppression vehicle 20. The height of the firefighting water supply pipe 40 is adjusted before the firefighting water supply pipe 40 docks with the firefighting water inflow pipe 14.

The height adjustment module 27 includes a first magnet 27a mounted on the connector 43 of the firefighting water supply pipe 40, and a second magnet 27b mounted on the body of the fire suppression vehicle 20 and spaced from the first magnet 27a in the vertical direction. One of the first magnet 27a and the second magnet 27b is a permanent magnet, and the other one is an electromagnet which generates magnetic force to move the connector 43 of the firefighting water supply pipe 40 in the vertical direction when current is applied to the electromagnet.

Referring to FIG. 8, the first magnet 27a may be fixedly mounted on the upper end portion of the connector 43, and the second magnet 27b may be fixedly mounted on a mounting bracket 27c fixed to the body of the fire suppression vehicle 20.

In the exemplary embodiment of the present disclosure, the first magnet 27a may be a permanent magnet, and the second magnet 27b may be an electromagnet. A current value applied to the electromagnet may be controlled by the controller 21 of the fire suppression vehicle 20. The vertical movement amount of the connector 43 is determined by the intensity of current applied to the electromagnet, and the movement direction of the connector 43 is determined by the direction of the current applied to the electromagnet. For example, when current of a positive (+) value is applied to the second magnet 27b, attractive force acts between the first magnet 27a and the second magnet 27b, and accordingly, the connector 43 of the firefighting water supply pipe 40 may be elevated. Furthermore, when current of a negative (−) value is applied to the second magnet 27b, repulsive force acts between the first magnet 27a and the second magnet 27b, and accordingly, the connector 43 of the firefighting water supply pipe 40 may be lowered.

The current value applied to the second magnet 27b is determined based on the vertical movement amount of the firefighting water supply pipe 40 to locate the firefighting water supply pipe 40 at a same height as the firefighting water inflow pipe 14. The vertical movement amount of the firefighting water supply pipe 40 may be determined by the controller 21 of the fire suppression vehicle 20. The controller 21 may be configured to determine the vertical movement amount of the firefighting water supply pipe 40 based on a height difference between the firefighting water inflow pipe 14 and the firefighting water supply pipe 40.

Horizontal movement of the connector 43 is restricted by the stopper 38 mounted on the body of the fire suppression vehicle 20. The stopper 38, which is a locking device for the connector 43, is connected to the body of the fire suppression vehicle 20 by the motor 38a for moving the stopper 38 to be mounted on the body of the fire suppression vehicle 20, and is connected to the motor 38a for moving the stopper 38 through a rack and pinion gear set 38b Therefore, the stopper 38 may be linearly moved in a direction of separating from the connector 43 through driving of the motor 38a for moving the stopper 38. Referring to FIG. 10, the connector 43 separated from the stopper 38 may be moved not only in the vertical direction but also in the horizontal direction.

Furthermore, the connector 43 may be moved in the vertical direction even before the connector 43 is separated from the stopper 38 (i.e., even in the state in which the connector 43 is coupled to the stopper 38. For the present purpose, a guide groove 38c into which one end portion of the connector 43 is inserted is provided in the stopper 38. The guide groove 38c is indented into the upper end portion of the stopper 38 in the vertical direction.

The connector 43 is linearly moved in the vertical direction by magnetic force generated by the second magnet 27b, and is not moved due to friction with the stopper 38 when magnetic force is not generated. For the present purpose, surface friction between the connector 43 and the guide groove 38c of the stopper 38 is set to a greater value than gravity applied to the connector 43.

Furthermore, as an exemplary embodiment of the present disclosure, the connector 43 may be coupled to the stopper 38 to be located at the lowermost position based on the height of the firefighting water inflow pipe 14 depending on a vehicle type, and the firefighting water supply pipe 40 may be moved to the same height as the firefighting water inflow pipe 14 only by elevating the connector 43. In the instant case, the connector 43 is located at the lowermost position in the guide groove 38c of the stopper 38 before the firefighting water supply pipe 40 is moved by magnetic force.

Referring to FIG. 4 and FIG. 5, the firefighting water inflow pipe 14 includes a first end portion (i.e., an inlet) neighboring to an inflow pipe opening 14a provided on one side of the body of the inflamed vehicle 10, and a second end portion (i.e., an outlet) connected to the battery cases 2 of the battery packs 1 provided in the vehicle occurrence vehicle 10. The inflow pipe opening 14a is opened or closed by a flap 14b provided on the side of the body of the inflamed vehicle 10.

The firefighting water inflow pipe 14 discharges the firefighting water supplied through the firefighting water supply pipe 40 to the insides of the battery cases 2. The firefighting water supplied to the firefighting water inflow pipe 14 through the firefighting water supply pipe 40 may flow into the battery cases 2 to fill the insides of the battery cases 2.

The flap 14b of the inflamed vehicle 10 may be provided to open or close the inflow pipe opening 14a by an actuator including a motor and a rack and pinion gear set. Therefore, the flap 14b may open or close the inflow pipe opening 14a while being elevated and lowered by driving of the actuator. Operation of the flap 14b may be controlled by the controller 12 of the inflamed vehicle 10, and the controller 12 is configured to control operation of the actuator so that the flap 14b opens the inflow pipe opening 14a, upon determining that the fire occurs in the inflamed vehicle 10. The flap 14b is controlled to open the inflow pipe opening 14a at a point in time when the fire occurs in the inflamed vehicle 10.

Hereinafter, a process of docking the fire suppression vehicle 20 with the inflamed vehicle 10 using the above-described docking apparatus for the fire suppression system according to an exemplary embodiment of the present disclosure will be described.

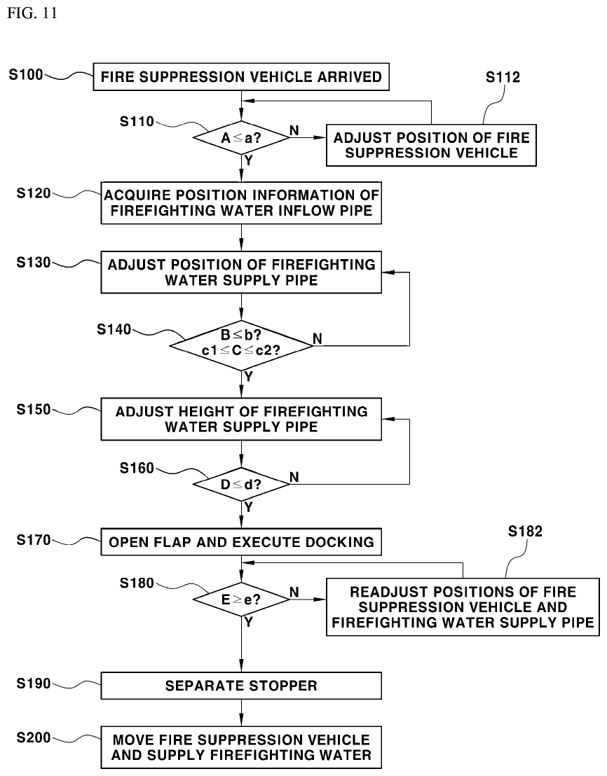

FIG. 11 is a flowchart representing a docking method for the fire suppression system according to various exemplary embodiments of the present disclosure.

Referring to FIG. 11, when the fire suppression vehicle 20 travels and arrives at a first position where the first suppression vehicle docks with the inflamed vehicle 10 at the request of the inflamed vehicle 10 (S100), the autonomous controller 25 of the fire suppression vehicle 20 is configured to determine a distance A between the firefighting water inflow pipe 14 and the firefighting water supply pipe 40. The autonomous driving controller 25 compares the determined distance A to a predetermined first distance value a (S110), adjusts the position of the fire suppression vehicle 20, when the determined distance A exceeds the first distance value a (S112), and executes more precise control to move the firefighting water supply pipe 40 to a second position where docking with the firefighting water inflow pipe 14 is possible, when the determined distance A is less than or equal to the first distance value a.

Here, the first position is a position within a predetermined radial distance from the inflamed vehicle 10, and the second position is a position where the extension pipe 42 of the firefighting water supply pipe 40 is capable of docking with the firefighting water inflow pipe 14 of the inflamed vehicle 10 due to extension of the extension pipe 42.

The distance A between the firefighting water inflow pipe 14 and the firefighting water supply pipe 40 is determined based on position information of the firefighting water inflow pipe 14 and position information of the firefighting water supply pipe 40. Here, the position information of the firefighting water inflow pipe 14 may be determined based on the position information and vehicle type information of the inflamed vehicle 10, and the position information of the firefighting water supply pipe 40 may be determined based on the position information and vehicle type information of the fire suppression vehicle 20. For the present purpose, the autonomous driving controller 25 of the fire suppression vehicle 20 may make a request for the vehicle type information and position information of the inflamed vehicle 10 to the inflamed vehicle 10, and may receive the vehicle type information and position information of the inflamed vehicle 10 from the inflamed vehicle, when the fire suppression vehicle 20 arrives at the first position (S120).

The positions of the firefighting water inflow pipe 14 and the firefighting water supply pipe 40 may indicate the positions of respective end portions of the firefighting water inflow pipe 14 and the firefighting water supply pipe 40. More concretely, the end portions of the firefighting water inflow pipe 14 and the firefighting water supply pipe 40 may indicate the inlet of the firefighting water inflow pipe 14 and the outlet of the firefighting water supply pipe 40, and the positions of the inlet of the firefighting water inflow pipe 14 and the outlet of the firefighting water supply pipe 40 may mean the radial centers thereof.

Furthermore, the autonomous driving controller 25 of the fire suppression vehicle 20 may obtain image information of the firefighting water inflow pipe 14 provided in the inflamed vehicle 10 through the camera which is one of autonomous driving sensors 24 provided in the fire suppression vehicle 20, and may more accurately detect the position of the end portion (i.e., the inlet) of the firefighting water inflow pipe 14, with which the firefighting water supply pipe 40 docks, from the obtained image information (S120). For the present purpose, a designated mark, which may be recognized by the camera of the fire suppression vehicle 20, may be provided on the end portion of the firefighting water inflow pipe 14. For example a quick response (QR) code, which may be recognized by the camera of the fire suppression vehicle 20, may be provided on the end portion of the firefighting water inflow pipe 14.

The autonomous driving controller 25 may more precisely adjust the position of the firefighting water supply pipe 40 based on the position information of the firefighting water inflow pipe 14 obtained at the first position. The autonomous driving controller 25 may recognize the horizontal position and vertical position of the firefighting water inflow pipe 14 based on the image information obtained through the camera together with the vehicle type information and position information of the inflamed vehicle 10. The position of the firefighting water inflow pipe 14 provided in the inflamed vehicle 10 is determined depending on the vehicle type of the corresponding inflamed vehicle 10.

The autonomous driving controller 25 is configured to perform autonomous driving control of controlling operation of a steering device and the drive motor 26 of the fire suppression vehicle 20 so that the fire suppression vehicle 20 may be moved to the position for docking between the firefighting water inflow pipe 14 and the firefighting water supply pipe 40, based on the vehicle type information and position information of the inflamed vehicle 10 and the image information obtained through the camera.

The autonomous driving controller 25 may adjust the horizontal position of the firefighting water supply pipe 40 to coincide with the horizontal position of the firefighting water inflow pipe 14 by moving the fire suppression vehicle 20 (S130), and may adjust the vertical position of the firefighting water supply pipe 40 to coincide with the vertical position of the firefighting water inflow pipe 14 by controlling driving of the height adjustment module 27 (S150).

The height adjustment module 27 is driven in the stopped state of the fire suppression vehicle 20, and adjusts the vertical position of the firefighting water supply pipe 40 through control of current applied to the electromagnet. Driving of the height adjustment module 27 may be controlled by the autonomous driving controller 25 or the controller 21 of the fire suppression vehicle 20.

After adjusting the horizontal position of the firefighting water supply pipe 40 in Operation S130, the autonomous driving controller 25 is configured to determine whether or not distances between the firefighting water supply pipe 40 and the firefighting water inflow pipe 14 satisfy first conditions (S140). Concretely, in Operation S140, the autonomous driving controller 25 is configured to determine whether or not a distance B in the leftward and rightward directions between the firefighting water supply pipe 40 and the firefighting water inflow pipe 14 is less than or equal to a predetermined second distance value b, and is configured to determine whether or not a distance C in the forward and rearward directions between the firefighting water supply pipe 40 and the firefighting water inflow pipe 14 is greater than or equal to a predetermined third distance value c1 but is less than or equal to a predetermined fourth distance value c2. The autonomous driving controller 25 readjusts the horizontal position of the firefighting water supply pipe 40 by adjusting the position of the fire suppression vehicle 20 (S130), upon determining that the distances between the firefighting water supply pipe 40 and the firefighting water inflow pipe 14 do not satisfy the first conditions.

Furthermore, after adjusting the vertical position of the firefighting water supply pipe 40 in Operation S150, the autonomous driving controller 25 is configured to determine whether or not the vertical position (i.e., the height) of the firefighting water supply pipe 40 coincides with the height of the firefighting water inflow pipe 14 (S160). The autonomous driving controller 25 executes Operation S170, upon determining that a height difference D between the firefighting water supply pipe 40 and the firefighting water inflow pipe 14 is less than or equal to a predetermined value d, and readjusts the height of the satisfies first conditions (S150), upon determining that the height difference D between the firefighting water supply pipe 40 and the firefighting water inflow pipe 14 exceeds the predetermined value d.

In Operation S170, the flap 29 of the fire suppression vehicle 20 opens the supply pipe opening 28, the extension pipe 42 of the firefighting water supply pipe 40 extends toward the firefighting water inflow pipe 14 by the spring member 44 via the supply pipe opening 28, and accordingly, the joint 42d of the extension pipe 42 docks with the end portion of the firefighting water inflow pipe 14 by press fitting. Here, the motor 29a for moving the flap 29 may be controlled by the controller 21 or the autonomous driving controller 25 of the fire suppression vehicle 20.

The autonomous driving controller 25 is configured to determine whether or not docking between the firefighting water inflow pipe 14 and the firefighting water supply pipe 40 is completed based on a pressure value E obtained from the pressure sensor 46 of the extension pipe 42 (S180). In Operation S180, the autonomous driving controller 25 is configured to determine that docking between the firefighting water inflow pipe 14 and the firefighting water supply pipe 40 is completed, when the pressure value E measured by the pressure sensor 46 is greater than or equal to a predetermined pressure value e, and is configured to determine that docking between the firefighting water inflow pipe 14 and the firefighting water supply pipe 40 is not completed, when the pressure value E measured by the pressure sensor 46 is less than the predetermined pressure value e.

From a point in time when docking between the firefighting water inflow pipe 14 and the firefighting water supply pipe 40 is completed, current is no longer applied to the second magnet 27b. When docking between the firefighting water inflow pipe 14 and the firefighting water supply pipe 40 is not completed, the autonomous driving controller 25 may readjust the position of the fire suppression vehicle 20 and the position of the firefighting water supply pipe 40 (S182), and may then attempt docking between the firefighting water inflow pipe 14 and the firefighting water supply pipe 40 again.

When docking between the firefighting water inflow pipe 14 and the firefighting water supply pipe 40 is completed, the autonomous driving controller 25 separates the stopper 38 from the connector 43 of the firefighting water supply pipe 40 by driving the motor 38a for moving the stopper 38 (S190). When the connector 43 is separated from the stopper 38, locking (i.e., movement restriction) of the connector 43 with the stopper 38 is released, and thus, the connector 43 becomes in a state of being able to be withdrawn to the outside of the body of the fire suppression vehicle 20 via the supply pipe opening 28 together with the flexible hose 41.

Thereafter, to secure a safe distance for the fire suppression vehicle 20, the autonomous driving controller 25 moves the fire suppression vehicle 20 in a direction away from the inflamed vehicle 10 to increase the distance between the fire suppression vehicle 20 and the inflamed vehicle 10 in Operation S200.

Although FIG. 6 illustrates the flexible hose 41 as having a short length, the flexible hose 41 may actually be provided to have a predetermined long length, and may be received in the body of the fire suppression vehicle 20. Therefore, in a docking state in which the extension pipe 42 of the fire suppression vehicle 20 is connected to the firefighting water inflow pipe 14 of the inflamed vehicle 10 through the joint 42d, as shown in FIG. 7, when the fire suppression vehicle 20 is moved, the flexible hose 42 may be deployed to extend to the outside of the body of the fire suppression vehicle 20.

FIG. 6 illustrates a state in which two fire suppression vehicles 20 simultaneously dock with the inflamed vehicle 10. Two fire suppression vehicles 20 may simultaneously dock with the inflamed vehicle 10 in the opened state of the flaps 14b and 29 of the inflamed vehicle 10 and the fire suppression vehicles 20, thus being configured for supplying firefighting water to the inflamed vehicle 10.

FIG. 7 illustrates a state in which the fire suppression vehicle 20 is moved in a direction away from the inflamed vehicle 10 in the docking state of the fire suppression vehicle 20 with the inflamed vehicle 10.

As shown in the present figure, when the fire suppression vehicle 20 docks with the inflamed vehicle 10, the extension pipe 42 of the fire suppression vehicle 20 is connected to the firefighting water inflow pipe 14 of the inflamed vehicle 10 by the joint 42d, and in the instant state, the fire suppression vehicle 20 may be moved in the direction away from the inflamed vehicle 10 to secure a safe distance.

Therefore, the firefighting water stored in the tank 35 may be supplied to the firefighting inflow pipe 14 of the inflamed vehicle 10 through the firefighting water supply pipe 40 by driving the pump 36 of the fire suppression vehicle 20, in the state in which the safe distance for the fire suppression vehicle 20 is secured (S200).

Thereafter, when a fire engine arrives around the inflamed vehicle 10, the flexible hose 41 may be separated from the extension pipe 42 connected to the firefighting water inflow pipe 14 of the inflamed vehicle 10, and a fire hose of the fire engine may be connected to the extension pipe 42, by operating the connector 43 between the flexible hose 41 and the extension pipe 42 of the firefighting water supply pipe 40. Here, firefighting water stored in the tank of the fire engine is supplied to the inside of the inflamed vehicle 10 (the inside of the battery pack) through the extension pipe 42 and the firefighting water inflow pipe 14.

The flexible hose 41 may be configured to be detachably coupled to the connector 43 by a general quick connector-type connecting member 41a. Therefore, the connecting member 41a may be separated from the connector 43 by moving the fire suppression vehicle 20 again in the direction away from the inflamed vehicle 10.

The above-described docking process between the firefighting water inflow pipe 14 and the firefighting water supply pipe 40 may be performed through cooperative control between the controller 12 of the inflamed vehicle 10 and the autonomous driving controller 25 of the fire suppression vehicle 20, or may be performed through cooperative control between the controller 12 of the inflamed vehicle 10 and the autonomous driving controller 25 and the controller 21 of the fire suppression vehicle 20.

Furthermore, the fire suppression system according to various exemplary embodiments of the present disclosure further includes a compensation system configured to provide economic compensation to a driver of a vehicle participating in fire suppression.

FIG. 12 is a block diagram illustrating the fire suppression system according to various exemplary embodiments of the present disclosure, including the compensation system, and illustrates the server of the fire station 70, a server of a vehicle manufacturer 50, the controller of the inflamed vehicle 10, and the controller of the fire suppression vehicle 20.

When the surrounding vehicle 20 located within the set radial distance from the inflamed vehicle 10 receives fire occurrence information and the driver of the surrounding vehicle 20 selects and inputs fire suppression participation, the corresponding surrounding vehicle 20 may be selected as a fire suppression vehicle 20, and in the instant case, economic and financial compensation to the selected fire suppression vehicle 20 may be provided.

The compensation system may be operated through collaboration between the service provider (i.e., the vehicle manufacturer) 50, and an insurance company 60, and the compensation system includes the server of the service provider 50 and a server of the insurance company 60.

The server of the service provider 50 and the server of the insurance company 60 are servers which are connected to each other to be communicable with each other through the Internet or other wired and wireless communication networks, and the compensation system provides a compensation service of giving financial and economic benefits, such as a coupon, cash (money), or a discount on vehicle insurance, to the driver of the fire suppression vehicle 20 connected to these servers, after participating in fire suppression.

The driver of the inflamed vehicle 10 is registered as a member of the service provider 50 in advance to easily get help with fire suppression from other vehicles in case of fire, and the driver registered as a member is supported by a fire suppression service in the event of a fire actually occurring in the vehicle 10.

In various exemplary embodiments of the present disclosure, the service provider 50 may be the vehicle manufacturer 50 which has manufactured the inflamed vehicle 10, and the insurance company 60 may be an insurance company which operates vehicle insurance taken out by the driver of the inflamed vehicle 10.

Referring to FIG. 12, the server of the fire station 70 receives the fire occurrence information from the controller of the inflamed vehicle 10, is configured to perform all processes to dispatch a fire engine, and transmits the position of the fire engine to the fire suppression vehicle 20 in real time until the fire engine arrives at the position of the inflamed vehicle 10.

Therefore, the fire suppression vehicle 20 may confirm the position of the fire engine, and may be moved to a safe place from the inflamed vehicle 10 a set time before arrival of the fire engine at the scene of a fire. Here, in addition to fire suppression vehicles 20 standing by, the fire suppression vehicle 20 connected to the inflamed vehicle 10 to supply firefighting water to the inflamed vehicle 10 may be separated from the inflamed vehicle 10, and may be moved to the safe place.

Among elements of the compensation system, the server of the service provider (i.e., the vehicle manufacturer) 50 receives information indicating whether or not a fire occurs and the overall vehicle state information from the vehicle (i.e., the inflamed vehicle) 10 of the driver having joined the service, and the service provider 50 is configured to determine the cause of the fire by analyzing the received vehicle state information.

Furthermore, the service provider 50 may receive vehicle fire-related information, such as whether or not the fire is suppressed, a time taken to suppress the fire, and fire state information, from the inflamed vehicle 10, and may use the information in big data analysis on future vehicle fires. The fire state information may include internal temperatures of the battery packs 1 detected by the temperature sensors 5, a concentration of gas, such as carbon monoxide, detected by the gas detector, and the like.

Furthermore, the server of the service provider 50 may be configured to determine whether or not the fire suppression vehicle 20 participates in fire suppression by receiving docking information from the fire suppression vehicle 20, and the fire suppression vehicle 20 transmits the docking information to the server of the service provider 50 only when the fire suppression vehicle 20 actually docks with the inflamed vehicle 10 and supplies firefighting water to the inflamed vehicle.

Therefore, the service provider 50 may confirm whether or not the fire suppression vehicle 20 actually participates in fire suppression based on the docking information of the corresponding fire suppression vehicle 20 received through the server of the service provider 50, and the server of the service provider 50 may transmit information, such as the numbers of times of fire suppression participation, about only drivers having received prior consent to the server of the insurance company 60.

The service provider 50 may confirm whether or not the fire suppression vehicle 20 participates in fire suppression, and may provide the compensation service of giving points, a coupon, or cash (money) to the driver of the fire suppression vehicle 20, and the insurance company 60 may confirm the number of times of fire suppression participation of each of respective vehicles, and may provide the compensation service of giving a discount on vehicle insurance corresponding to the number of times of fire suppression participation to a corresponding driver.

Furthermore, the server of the service provider 50 may receive information, such as an amount of supplied firefighting water obtained from a signal from the water level sensor 35a in the tank 35 of the fire suppression vehicle 20, whether or not the fire is suppressed, and an amount of gas backflow detected by the gas detector provided in the fire suppression vehicle 20, from the fire suppression vehicle 20, and the service provider 50 may use the information in big data analysis on future vehicle fires.

Furthermore, in the specification, the inflamed vehicle 10 may be referred as a “first vehicle”, and the fire suppression vehicle 20 may be referred to as a “second vehicle”. Moreover, in the specification, the motor 38a for moving the stopper 38 may be referred to as a “first motor” and the motor 29a for moving the flap 29 may be referred to as a “second motor”.

As is apparent from the above description, the present disclosure may provide a docking apparatus and method for a cooperative fire suppression system for vehicles which docks a surrounding vehicle with an inflamed vehicle to supply firefighting water to the inflamed vehicle, being capable of rapidly suppressing a fire occurring in the inflamed vehicle through cooperation with the surrounding vehicle.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A docking apparatus for a cooperative fire suppression system for vehicles, the docking apparatus comprising:
a firefighting water inflow pipe provided in a first vehicle to receive firefighting water;
a firefighting water supply pipe provided in a second vehicle to be capable of docking with the firefighting water inflow pipe, and moved to a position where docking with the firefighting water inflow pipe is possible through driving of the second vehicle; and
a height adjustment module provided in the second vehicle and configured to adjust a height of the firefighting water supply pipe to coincide with a height of the firefighting water inflow pipe.

2. The docking apparatus of claim 1,
wherein the height adjustment module includes a first magnet provided on the firefighting water supply pipe, and a second magnet mounted on the second vehicle and configured to be spaced from the first magnet in a vertical direction, and
wherein one of the first magnet and the second magnet is a permanent magnet, and a remaining one of the first magnet and the second magnet is an electromagnet configured to generate magnetic force to move the firefighting water supply pipe in the vertical direction in response that current is applied to the electromagnet.

3. The docking apparatus of claim 2, wherein a current value applied to the electromagnet is determined based on a movement amount of the firefighting water supply pipe, and the movement amount of the firefighting water supply pipe is a vertical movement amount of the firefighting water supply pipe to locate the firefighting water supply pipe at a same height as the firefighting water inflow pipe.

4. The docking apparatus of claim 1, wherein horizontal movement of the firefighting water supply pipe is restricted by a stopper provided in the second vehicle.

5. The docking apparatus of claim 4, wherein the stopper includes a guide groove configured so that a connector provided on the firefighting water supply pipe is inserted thereinto, and the guide groove is indented into the stopper in a vertical direction.

6. The docking apparatus of claim 5, wherein the stopper is moved in a direction of being separated from the connector of the firefighting water supply pipe by driving of a first motor provided in the second vehicle, in response that docking between the firefighting water inflow pipe and the firefighting water supply pipe is completed.

7. The docking apparatus of claim 2, wherein the firefighting water supply pipe includes:
a flexible hose including a first end portion connected to a tank of the second vehicle configured to store the firefighting water;
a connector provided on a second end portion of the flexible hose and provided with the first magnet mounted thereon; and
an extension pipe connected to the flexible hose through the connector, configured to be capable of extending in a longitudinal direction of the extension pipe, and include a joint coupled to the firefighting water inflow pipe.

8. The docking apparatus of claim 7, wherein the extension pipe is pressed in a direction of extending by a spring member in a compressed state provided on the connector.

9. The docking apparatus of claim 8, wherein the spring member is supported in the compressed state by a flap neighboring to the joint of the extension pipe, and the flap is configured to open or close a supply pipe opening provided in an external body of the second vehicle.

10. The docking apparatus of claim 9, wherein the flap opens the supply pipe opening by driving a second motor, in response that the firefighting water supply pipe is located at the position where the docking with the firefighting water inflow pipe is possible.

11. The docking apparatus of claim 7, wherein a pressure sensor configured for measuring a pressure applied to the joint coupled to the firefighting water inflow pipe is provided on the extension pipe, and whether docking between the firefighting water inflow pipe and the extension pipe is executed is determined based on a pressure value measured by the pressure sensor.

12. The docking apparatus of claim 1, wherein the firefighting water inflow pipe is connected to battery cases of battery packs provided in the first vehicle, and the firefighting water supplied to the firefighting water inflow pipe through the firefighting water supply pipe flows into the battery cases.

13. A docking method for a cooperative fire suppression system for vehicles, the docking method comprising:
moving a second vehicle including a firefighting water supply pipe to a first position within a predetermined distance from a first vehicle including a firefighting water inflow pipe at a request of the first vehicle;
moving the firefighting water supply pipe to a second position where docking with the firefighting water inflow pipe is possible based on position information of the firefighting water inflow pipe by driving of the second vehicle and operation of a height adjustment module provided in the second vehicle, in response that the second vehicle arrives at the first position;
extending an extension pipe provided in the firefighting water supply pipe toward the firefighting water inflow pipe by opening a flap configured to open or close a supply pipe opening provided in an external body of the second vehicle, in response that the firefighting water supply pipe is located at the second position; and
docking the extended extension pipe with the firefighting water inflow pipe to supply firefighting water to the firefighting water inflow pipe.

14. The docking method of claim 13, wherein the moving the firefighting water supply pipe to the second position includes:
moving the second vehicle so that a horizontal position of the firefighting water supply pipe coincides with a horizontal position of the firefighting water inflow pipe; and
moving the firefighting water supply pipe in a vertical direction by the height adjustment module so that a vertical position of the firefighting water supply pipe coincides with a vertical position of the firefighting water inflow pipe.

15. The docking method of claim 14,
wherein the height adjustment module includes a first magnet provided on the firefighting water supply pipe, and a second magnet mounted on the second vehicle and configured to be spaced from the first magnet in a vertical direction, and
wherein one of the first magnet and the second magnet is a permanent magnet, and a remaining one of the first magnet and the second magnet is an electromagnet configured to generate magnetic force to move the firefighting water supply pipe in the vertical direction in response that current is applied to the electromagnet.

16. The docking method of claim 15, wherein a current value applied to the electromagnet is determined based on a movement amount of the firefighting water supply pipe, and the movement amount of the firefighting water supply pipe is a vertical movement amount of the firefighting water supply pipe to locate the firefighting water supply pipe at a same height as the firefighting water inflow pipe.

17. The docking method of claim 15, wherein the firefighting water supply pipe includes:
a flexible hose including a first end portion connected to a tank of the second vehicle configured to store the firefighting water;
a connector provided on a second end portion of the flexible hose and provided with the first magnet mounted thereon; and
the extension pipe connected to the flexible hose through the connector, configured to be capable of extending in a longitudinal direction of the extension pipe, and pressed in a direction of extending by a spring member in a compressed state provided on the connector.

18. The docking method of claim 17,
wherein the spring member is supported in the compressed state by a flap neighboring to an end portion of the extension pipe, and
wherein the extension pipe extends toward the firefighting water inflow pipe by elastic restoring force of the spring member in response that the flap opens the supply pipe opening.

19. The docking method of claim 13,
wherein the docking the extending extension pipe with the firefighting water inflow pipe includes determining whether docking between the firefighting water inflow pipe and the firefighting water supply pipe is completed based on a pressure value measured by a pressure sensor provided on the extension pipe of the firefighting water supply pipe, and
wherein, in response that the pressure value measured by the pressure sensor is greater than or equal to a set pressure value, a determination is made that the docking between the firefighting water inflow pipe and the firefighting water supply pipe is completed.

20. The docking method of claim 19, further including:
separating a stopper configured to restrict horizontal movement of the firefighting water supply pipe from the firefighting water supply pipe, in response that the docking between the firefighting water inflow pipe and the firefighting water supply pipe is completed;
securing a safe distance for the second vehicle by moving the second vehicle in a direction away from the first vehicle; and
supplying the firefighting water in a tank provided in the second vehicle to the firefighting water inflow pipe through the firefighting water supply pipe,
wherein the firefighting water inflow pipe is connected to battery cases of battery packs provided in the first vehicle, and the firefighting water supplied to the firefighting water inflow pipe through the firefighting water supply pipe flows into the battery cases.
